(19) United States
(12) Patent Application Publication
(10) Pub. No.: US 2009/0031133 A1
(43) Pub. Date: Jan. 29, 2009

(54) METHOD AND SYSTEM FOR SCREENING AND AUTHORIZING CONTENT

(76) Inventor: Hagai Bar-El, Rehovot (IL)

Correspondence Address: EMPK & Shiloh, LLP;c/o Landon IP, Inc., 1700 Diagonal Road, Suite 450, Alexandria, VA, 22314, US

(21) Appl. No.: 12/141,308

(22) Filed: Jun. 18, 2008

Related U.S. Application Data
(60) Provisional application No. 60/929,222, filed on Jun. 18, 2007.

(51) Int. Cl. H04L 9/00

(52) U.S. Cl. 713/176

(57) ABSTRACT

Apparatus and method are disclosed for preventing the use of disapproved received electronic content on a Mobile Station. The apparatus and method may include modules for extracting and comparing fingerprints of the received content on the Mobile Station to fingerprints of disapproved content, and for the activation of an authorization process based on the results of the comparison, as well as on the decisions of the user whether to purchase authorization when it is required. A cryptography-based check-in procedure is introduced to assure that all content has passed the verification phase.

### CROSS REFERENCE TO RELATED APPLICATIONS

This application claims the benefit of U.S. Provisional Application Ser. No. 60/929,222, filed on Jun. 18, 2007 and entitled METHOD AND SYSTEM FOR SCREENING AND AUTHORIZING COPYRIGHTED CONTENT, which is incorporated in its entirety herein by reference.

### BACKGROUND OF THE INVENTION

Copyrighted electronic content may be protected against illegal or unauthorized use in known ways, such as digital rights management (DRM), which is an umbrella term referring to technologies used by publishers or copyright owners to control access to, or usage of, digital data. Such technologies often involve the encryption of the representation of such content, so to allow better control over its distribution.

DRM systems differ in their robustness. Robustness is affected by the design of the DRM schemes, as well as by factors related to the platforms that the DRM systems run on. For example, it is perceived that closed platforms (that is, platforms which cannot be introduced with unapproved software) are more suitable for DRM deployments than open platforms (that is, platforms on which the user can install software of his/her choice). When a DRM system (or implementation) is broken, the result may be the availability of previously-encrypted content in plaintext (unencrypted) form. Content in an unencrypted (and thus unprotected) form may be distributed freely against the will of, and/or without proper compensation to, the owner of the distribution rights on that content. Content that its legal distributor wishes to control the distribution of, while such content being represented in an unencrypted form is further referred to as ‘unprotected content’.

Unprotected content can be distributed and introduced also to devices that run an intact DRM module. The DRM module on such devices, made to handle the consumption of protected content, may not be adapted to moderate the consumption of such unprotected content.

Often, moderation of content consumption is accomplished by using data objects that include the expression of restrictions on the usage of that content using some notation. These data objects, sometimes referred to as Rights Objects, also contain a key that is used to decrypt the encrypted content object. Such encryption forms the means that bind the content to its Rights Object. If the content is available in its plaintext (that is, unencrypted) form, then it may be used without consulting the Rights Object, and often with no way of knowing that such a Rights Object exists for that content.

Therefore, to some extent, the robustness of the DRM system relies on content availability only in protected (i.e., encrypted) form. The effectivity of the DRM system on a device may be hampered when unprotected content is introduced to the device.

Consequently, the DRM mechanisms on reasonably protected environments, such as those of a Mobile Station (MS), such as a cellular phone or a Personal Media Player (PMP) may fail to provide the expected protective measures when receiving unauthorized, e.g., pirated, unprotected content. Such unprotected content may be received from a less protected machine, such as a Personal Computer (PC), e.g., as a result of a compromise of a DRM system that may have occurred on this or other machine.

Regardless of the strength of the DRM mechanism on the MS, unprotected content may be publicly available, for example, for acquisition through the Internet. This unprotected content will be made available for download and consumption, e.g., on PC machines. As long as unprotected content can somehow be obtained, such unprotected content can be introduced into a MS and hamper the effectivity of the mobile content distribution business model. It is therefore of benefit to have a system and method that can provide a solution to protect a MS against receiving, storing, and/or playing, certain types of unprotected content. One desired outcome of such a solution is that the availability of unprotected content on, for example, PC environments, such as by utilizing CD ripping or by utilizing peer-to-peer sharing and the like, will not lead to consumption of such unprotected content on a MS, and thus will not weaken the business model of the robust DRM implementation on the MS.

### SUMMARY OF THE INVENTION

An apparatus and method are described for preventing and controlling the use of disapproved unprotected content. The apparatus and method may include modules for extracting fingerprints from the received electronic content items, for comparing the extracted fingerprints to fingerprints of disapproved unprotected content, and for activation of an authorization process based on the results of the comparison and on the decisions of a user as to whether to purchase authorization when it is required. The apparatus and method of the invention may disable use or playing of disapproved unprotected content. The apparatus and method may be implemented on various devices and in variety of environments.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic flow chart illustration of a method according to some embodiments of the present invention; and

FIG. 2 is a schematic block diagram illustration of a system according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. Moreover, some of the blocks depicted in the drawings may be combined into a single function.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

It is assumed that possession of unprotected content, as well as of disapproved unprotected content, such as illegally copied content, will always be possible on some platforms and/or in some environments other than a MS. Thus, the protection of a MS against storing and/or using disapproved unprotected content may preferably be done at the entrance of such content to a MS, and in a way that does not assume the entering content to be in a protected form. One of the ways to prevent plaintext seemingly-approved content, from being used on a MS in a non-approved manner is by using the secure execution foundation that is sometimes available on mobile platforms to detect and prevent the use of disapproved unprotected content, as disclosed herein.

Although the present invention is not limited in this respect, such disapproved unprotected content may be content that shall only be available on consumer platforms in a protected form, e.g., so that its usage can be moderated, such as by using a Digital Rights Management (DRM) scheme implemented on the MS.

Although the present invention is not limited in this respect, such disapproved unprotected content may be content that is considered disallowed for use for other legal and/or moral reasons.

Although the present invention is not limited in this respect, such disapproved unprotected content may take the form of sound tracks, or of movie clips.

Disapproved unprotected content may be filtered on a MS. Such filtering may require that disapproved unprotected content is positively identified. Identification of an electronic piece of media content may be accomplished using acoustic and/or video fingerprinting of that piece of content. The fingerprinting technology, as known in the art, allows the association of a piece of content with one or more corresponding “fingerprints” and the comparison of fingerprints of a first content item with fingerprints of a second content item. The association of fingerprints with a specific content item may be done according to one of several methods of extraction. The comparison between fingerprints may be done according to a given threshold and one or more criterions. A match between two fingerprints may be defined as a situation in which the level of resemblance between these two fingerprints based on that one or more criterions for determining resemblance exceeds that given threshold. The determination of the level of resemblance may be done according to methods known in the art. The second content item usually represents a known content object. Such fingerprint comparison may resemble in its effect a bitwise comparison of content files, with the exception that it cannot be foiled by simple alteration of the tested content item, such as by slightly truncating it, or by changing its digitization properties. This comparison may return an indication value which may be indicative of the resemblance of the first content item and the second content item. The indication value may have a “yes/no” value indicating whether the two content items “match” each other or “do not match”, in case where an examined content item is compared to a reference content item. Indication value may have one of two or more discrete values indicative of the association of the comparison result with one of a group of possible results.

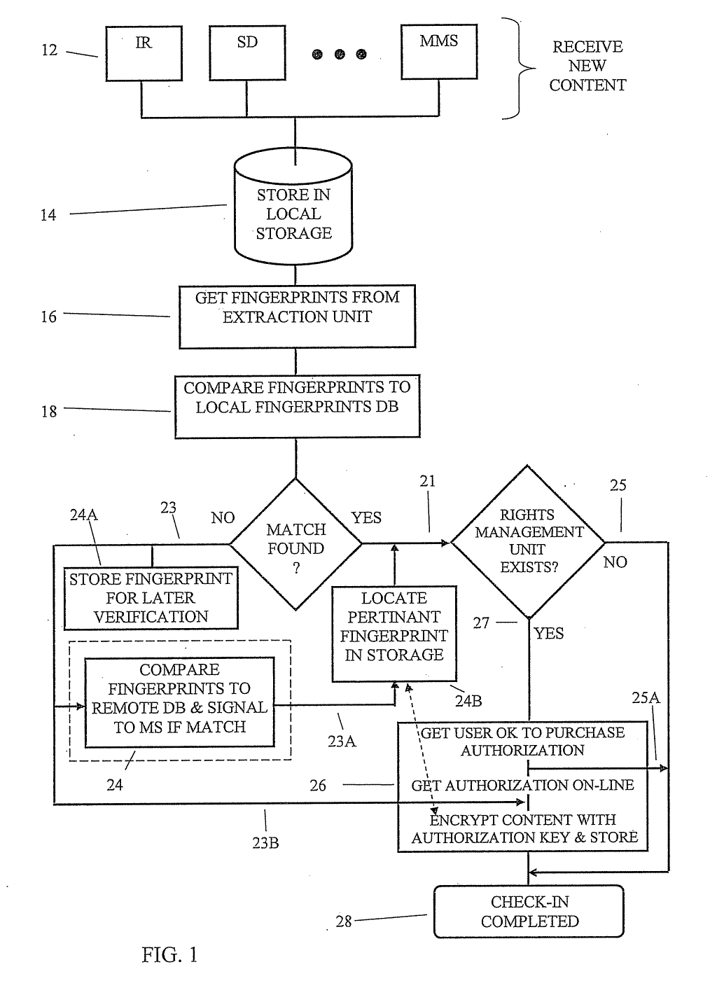

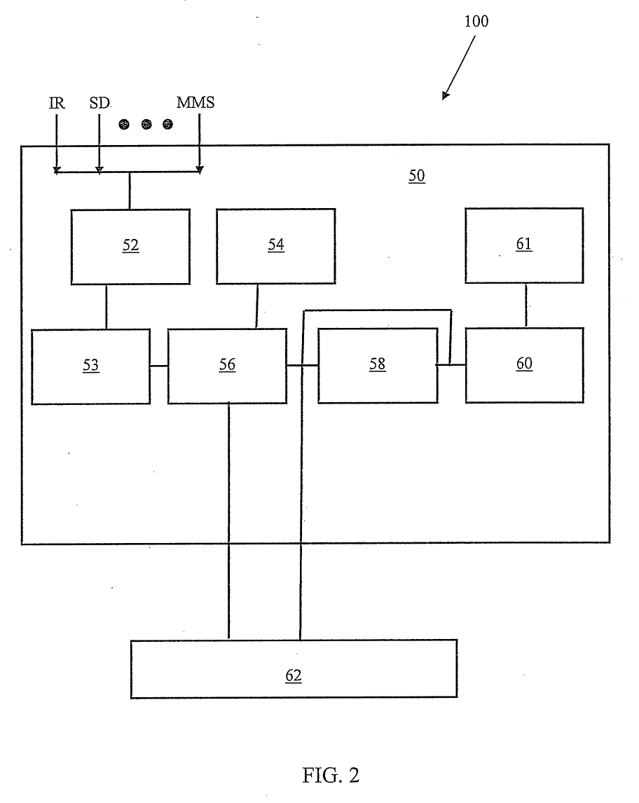

Reference is made now to FIG. 1, which is a schematic flow chart illustration of a method according to some embodiments of the present invention and to FIG. 2, which is a schematic block diagram illustration of a System 100, according to some embodiments of the present invention.

FIG. 2 depicts a System 100, which may comprise a MS 50, such as a cellular telephone device or the like and fingerprint storage unit(s) 62. MS 50 may comprise a local storage unit 52 for storing incoming electronic content items (also referred to as content objects), received from any available input channel such as Infra Red (IR) input, storage cards such as SD cards (memory cards specified by the SD Association (SDA)) or MMC cards (memory cards as specified by the Multi Media Card Association (MMCA)), Multimedia Messaging System (MMS), direct download, and the like. MS 50 may further comprise a Fingerprints Extraction Unit 53 to extract fingerprints from the incoming electronic content items stored in local storage unit 52, and local bank 54 to store fingerprints of disapproved unprotected content items. MS 50 may further comprise a fingerprints comparison unit 56 to compare fingerprints extracted by fingerprints extraction unit 53 to fingerprints stored in local bank 54. Fingerprints comparison unit 56 may be further connectable to remote fingerprints storage unit(s) 62 via, for example, a cellular link, for comparing the extracted fingerprint to fingerprints stored in the remote fingerprints storage unit(s) 62. Fingerprints storage unit(s) 62 may be part of a Management Server (not shown) but they may be separated from each other in other embodiments. Management Server may be responsible for carrying out the server-side of other relevant maintenance operations on MS 50, as explained below. MS 50 may further comprise a rights management unit 58 to allow the user to obtain clearance to use received content objects, following an authorization cycle that may comprise successful financial transaction. Successful financial transaction may assure that compensation has been obtained for the right to use the pertinent content objects. MS 50 may further comprise a content encryption unit 60 to encrypt, with authorization key, content items the fingerprints of which were not found to match fingerprints of disapproved unprotected content items, either stored locally in local bank 54 and/or remotely in fingerprints storage unit(s) 62, and content items which were cleared by rights management unit 58. Finally, MS 50 may comprise storage unit 61 to store content items encrypted with an authorization key. It would be apparent to a person skilled in the art that some or all units or modules having similar functions, such as memory or storage units, may be implemented in a single device and/or area as well as may be implemented, in other embodiments, in different physical units.

The flow of operations depicted in FIG. 1 may be carried out upon the entrance of electronic content into MS 50. Electronic content may be received from one or more of a variety of sources as indicated at block 12, such as an Infra Red (IR) communication channel, a SD channel, a Multimedia Messaging System (MMS) channel and the like. The incoming content may be stored in a local storage device 52 (as indicated at block 14). Fingerprints may then be extracted from the stored content (as indicated at block 16) by fingerprints extraction unit 53 and further be compared (as indicated at block 18) with fingerprints in a local bank of fingerprints of disapproved unprotected content files, stored, for example, in local bank 54 on MS 50 by fingerprints comparison unit 56. Such locally stored bank of fingerprints local bank 54 may typically comprise of fingerprints of several thousands of disapproved unprotected content items. For example, local bank 54 may comprise fingerprints of selected content items such as one or more hot-lists of disapproved unprotected content items included by their popularity, or by any other desired criteria. The comparison of the extracted fingerprint to those locally stored in local bank 54 may result in positive result (that is, a match of the extracted fingerprint to one locally stored fingerprint was found showing likelihood that the incoming content resembles the content item associated with the locally stored fingerprint), as indicated by path 21. This comparison may, in other cases, result in negative result, that is, no such match was found, as indicated by path 23.

The comparison of the extracted fingerprint to the ones stored in local bank 54 may take the form of matching by threshold rather than by bit-wise comparison. A Detection Threshold Parameter may be set and managed on MS 50 by the Management Server. Such Detection Threshold Parameter may form the balance between false positive and false negative rates of the detection, as known in the art.

The Management Server may modify the value of Detection Threshold Parameter at will, and may maintain different values for Detection Threshold Parameter for different instances of MS 50. The management of Detection Threshold Parameter by Management Server may be carried out by any communication protocol as known in the art, including, but not limited to, existing device management protocols that may already be used. In case positive match to locally stored fingerprints was found, and in case a rights management unit 58 exists in MS 50, the user may be offered by MS 50 an option to obtain authorization to use the electronic content item that was identified (as indicated by path 27). If the user approved receiving authorization to use that electronic content item, then an authorization cycle between the user and the owner of the distribution rights on that content item, or between the user and any other suitable entity, may be invoked. This cycle may comprise successful financial transaction that assures that compensation has been obtained for the right to use said content item. Once authorization to use the content item is received, said item is encrypted with authorization key (as indicated at block 26) by Content Encryption Unit 60 and may be saved as such in storage unit 61. If, however, a rights management unit 58 does not exist in MS 50 (as indicated by path 25) or the user does not purchase authorization to use the identified content item (as indicated by path 25A), then no authorization to use that content item is received and no encryption is done of that content item with an authorization key.

In case no match was found (as indicated by path 23), fingerprints of content items for which no match was found may be stored for later verification (as indicated at block 24A) and MS 50 may connect to external resources via, for example, cellular link, to trigger the comparison of the stored extracted fingerprints of incoming content items to remote databases of fingerprints stored in one or more instances of fingerprints storage unit(s) 62. If match was found to fingerprint(s) in remote fingerprints storage unit(s) 62 (as indicated by path 23A), then the pertinent file which was identified in block 24 and encrypted and saved as in block 26 may be located as indicated in block 24B and the flow may be merged as indicated to path 21 for further processing, as described above. Also, in case no match is found (as indicated by path 23, 23B), then the checked item is encrypted with authorization key (as indicated at block 26) by content encryption unit 60 and may be saved as such in Storage Unit 61. It shall be noted that the encryption operation and the decryption operation may be performed in a reversed order. The encryption and the decryption operations may be defined hereinbelow in general as cryptographic operations. Accordingly, content encryption unit 60 may be operated to perform decryption operation and decryption unit (not shown) may be operated to perform an encryption operation. Both operations may be referred to as cryptographic operations.

According to some demonstrative embodiments of the invention, the Management Server may occasionally modify the contents of local bank 54. For example, the Management Server may keep the contents of local bank 54 in line with one or more hot-lists of disapproved unprotected content items, according, for example, to their popularity.

According to some demonstrative embodiments of the invention, the Management Server may assure that local bank 54 contains fingerprints of disapproved unprotected content items for which immediate detection is most desired, that is, before a single consumption event, while allowing remote fingerprints storage unit(s) 62 to also contain fingerprints of disapproved unprotected content items that may be detected on MS 50 even after they were consumed at least once.

According to some demonstrative embodiments of the invention, the Management Server may assure that local bank 54 contains fingerprints of disapproved unprotected content items that are perceived to be more likely to be of interest to the particular user of MS 50. For example, the Management Server may determine that a particular user is likely to attempt consumption of a particular type of disapproved unprotected content and may thus compile the contents of local bank 54 in accordance to such determination.

According to some demonstrative embodiments of the invention, the Management Server may assure that local bank 54 contains fingerprints of disapproved unprotected content items that are perceived to cause a greater monetary damage by being consumed. For example, the Management Server may assure that local bank 54 contains fingerprints of the latest entertainment titles, such as ones that are considered to be “premium content”, so to prevent the user from consuming unprotected, i.e., pirated, copies of these titles.

The Management Server may modify the contents of local bank 54 at will, and may maintain different contents in local bank 54 for different instances of MS 50, e.g., by differentiating between user profiles, thus providing, for example, fingerprints extracted from MS-specific list of content items. The management of the contents of Local Bank 54 by Management Server may be carried out by any communication protocol as known in the art including but not limited to existing device management protocols that may already be used.

Finally, in order to ensure that only authorized content will be played on MS 50, a Decryption Unit Module (not shown) may be incorporated into MS 50. Incoming content items that have been authorized at the end of the above described process and were subsequently encrypted with authorization key can thus be played at MS 50 via the decryption unit module. Non-authorized content items, according to the procedure above, were not encrypted with the authorization key, and any attempt to play them will fail. The check-in process described above may end as indicated at block 28.

It will be noted that a content item received in MS 50 may be stored directly, without passing any step of the check-in process described above, in which case it will be stored without being first encrypted with an authorization key and thus will be unplayable on a MS 50. In such case, the user of MS 50 may have the option to later initiate the check-in process. Alternatively, the check-in process may follow right after the storing of the incoming electronic content item.

The methods presented above, including, but not limited to, the fingerprint extraction, comparison, content check-in, decryption and playback, may have their secure execution assured by means of trusted execution environments and/or any other security mechanisms.

According to some demonstrative embodiments of the invention, other forms of binding between the check-in procedure described above and consumption (e.g., playback) of the checked-in content item may be utilized. For example, the check-in procedure described above may include a step in which a digitally-signed “receipt” or “ticket”, as known in the art may be issued for checked-in content and the routines handling the playback of content may be tailored to verifying such “receipts” or “tickets” prior to carrying out the relevant operation needed for consumption. The digitally-signing of the “receipt” or “ticket” may also be referred to as cryptographic operations.

According to some demonstrative embodiments of the invention, other forms of binding between the check-in procedure described above and consumption (e.g., playback) of the checked-in content item maybe utilized. For example, the check-in procedure described above may include a step in which an identification value is associated with the checked-in content item and is recorded to indicate that said content item was checked-in. The identification values may be stored in any one of the storage means in MS 50, such as local storage unit 52, local bank 54 and the like. The routine handling the playback of content may be tailored to verifying that content items were deemed allowed before carrying out necessary playback operations. This verification may be referred to as a clearance action. In some embodiments of the invention operations of said decryption unit may also be referred to as clearance actions. According to embodiments of the invention said clearance action may be invoked with the consumption of said content item and may result in disallowance of the consumption.

According to some demonstrative embodiments of the invention, the outcome of the check-in procedure described above may be not the approval of the examined content item for consumption by act of encryption, but rather record-keeping, for later reporting to Management Server or to any other entity that may further use this information. According to such embodiments of the invention, the introduction of disapproved unprotected content to MS 50 is logged, and this information may be sent by any component of MS 50 to Fingerprints Storage Unit(s) 62, Management Server, or any other remote entity that collects such information. Although the present invention is not limited in this respect, such data can be used for purposes of billing.

According to some demonstrative embodiments of the invention, the local fingerprint comparison as indicated at block 18 may be omitted. Content items may be checked in by extracting their fingerprint, as indicated at block 16, and comparing the extracted fingerprint to fingerprints on Fingerprints Storage Unit(s) 62, as indicated at block 24. Content items may either be usable (hence, “checked-in”) or not usable, during the time frame between the time at which their fingerprints were extracted, until a response has arrived from Fingerprints Storage Unit(s) 62.

According to some demonstrative embodiments of the invention, the check-in process which starts with fingerprint extraction as indicated at block 16 may be triggered by the Decryption Unit Module, or by any other module on MS 50 that processes the content item when it is consumed. According to such embodiments, the content that is received by MS 50 is not processed as described above until the first time it is attempted to be used (i.e., consumed), at which point it is processed by Decryption Unit Module. As soon as the Decryption Unit Module attempts decryption of the content item, failure to do so will indicate that the content item has not gone through the procedure that included its encryption by Content Encryption Unit 60 as indicated at block 26, and may trigger the process that starts with fingerprint extraction, as indicated at block 16.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A mobile device comprising:
a fingerprints extraction unit to extract a first fingerprint of an incoming first electronic content item; and
a fingerprints comparison unit to perform fingerprint comparison of said extracted first fingerprint to at least one reference fingerprint being a second fingerprint;
wherein:
said fingerprints comparison is to determine an indication value indicative of the level of resemblance of said first content item to said second content item.

2. The device of claim 1 further comprising:
a link to a remote storage unit to enable comparison of said first fingerprint to at least one fingerprint stored in said remote storage unit being a third fingerprint.

3. The device of claim 1 further comprises a local bank to store said second fingerprint and to further store fingerprints of selected content items.

4. The device of claim 1 wherein said fingerprints comparison unit is further adapted to compare said first fingerprint and said second fingerprint according to at least one given criterion.

5. The device of claim 1 further comprises a content encryption unit to perform a first cryptographic operation to bind said indication value to said first content item.

6. The device of claim 1 further comprises a decryption unit to enable consumption of a content item based on said indication value.

7. The device of claim 1 wherein said device is further adapted to perform a clearance action when said first content item is consumed; and
wherein said consumption is based on an allowance by said clearance action.

8. The device of claim 3 wherein said fingerprints stored in said local bank extracted from device-specific list of content items.

9. A method for screening content in a mobile device:
receiving at least a first content item at said mobile device;
extracting a first fingerprint from said at least first content item; and
comparing said extracted first fingerprint to at least one reference fingerprint being a second fingerprint, said second fingerprint was extracted from a second content item;
wherein said comparing is to determine an indication value indicative of the level of resemblance of said first content item to a second content item.

10. The method of claim 9 further comprising:
communicating with a remote storage unit to send said first fingerprint for comparison with at least one fingerprint stored in said remote storage unit.

11. The method of claim 9 further comprising storing in a local storage unit fingerprints of a selected list of content items.

12. The method of claim 9 further comprising performing a first cryptographic operation to bind said indication value to said first content item.

13. The method of claim 9 further comprising enabling consumption of said content item by a decryption unit based on said indication value.

14. The method of claim 9 further comprising performing clearance action when said first content item is consumed,
wherein said consumption is based on an allowance by said clearance action.

15. The method of claim 9 further comprising storing in said local bank fingerprints extracted from device-specific list of content items.
